(19) United States
(12) Patent Application Publication
(10) Pub. No.: US 2026/0292269 A1
(43) Pub. Date: Sep. 24, 2026

(54) OBJECT DISPLAY METHOD, APPARATUS, DEVICE AND STORAGE MEDIUM

(71) Applicant: Beijing Youzhuju Network Technology Co., Ltd., Beijing (CN)

(72) Inventor: Yang CHENG, Beijing (CN)

(21) Appl. No.: 19/479,721

(22) PCT Filed: Jun. 6, 2024
(86) PCT No.: PCT/CN2024/097783

§ 371 Date: Oct. 28, 2025

(30) Foreign Application Priority Data
Jun. 30, 2023 (CN) 202310805278.5

(51) Int. Cl. H04N 21/2187; H04N 21/478

(52) U.S. Cl. CPC H04N 21/2187; H04N 21/47815

(57) ABSTRACT

The present application relates to an object display method and apparatus, a device, and a storage medium. The method includes: displaying a first page, where a first object and a first topic word are displayed on the first page, the first object belongs to a first object set obtained by aggregation based on the first topic word, and an object in the first object set has a description feature corresponding to the first topic word (S101); and displaying a second page in response to a preset trigger operation for the first topic word, where a second object is displayed on the second page, the second object belongs to the first object set, and the second object includes at least one type of object from a live streaming object, a video object, an image-text object and a life service object (S102).

### CROSS-REFERENCE TO RELATED APPLICATION(S)

The present application claims priority to Chinese Patent Application No. 202310805278.5, filed on Jun. 30, 2023, and entitled “OBJECT DISPLAY METHOD AND APPARATUS, DEVICE, AND STORAGE MEDIUM”, which is incorporated herein by reference in its entirety.

### FIELD

The present disclosure relates to the field of computer processing technologies, and in particular, to an object display method and apparatus, a device, and a storage medium.

### BACKGROUND

With the development of Internet technologies, Internet live streaming, short video browsing, and the like have become increasingly prevalent forms of leisure and entertainment. Currently, people have increasingly diverse display requirements for media resource objects, article objects, etc.

Therefore, how to meet people's diverse display requirements for media resource objects, article objects, etc. is a technical problem that needs to be solved urgently at present.

### SUMMARY

To solve the technical problem described above, embodiments of the present disclosure provide an object display method.

According to a first aspect, an embodiment of the present disclosure provides an object display method. The method includes:
displaying a first page, where a first object and a first topic word are displayed on the first page, the first object belongs to a first object set obtained by aggregation based on the first topic word, and an object in the first object set has a description feature corresponding to the first topic word; and
displaying a second page in response to a preset trigger operation for the first topic word, where at least one second object is displayed on the second page, the at least one second object belongs to the first object set, and the at least one second object includes at least one type of object from a live streaming object, a video object, an image-text object, and a life service object.

In an optional implementation, the first object set is determined based on a live streaming object set corresponding to a target live streaming room, and the first topic word is determined based on the target live streaming room;
or the first object set is determined based on a listed object set corresponding to a first list, and the first topic word is determined based on a list name of the first list;
or the first object set is determined based on a new product object set, and the first topic word is a new product description word;
or the first object set is determined based on an object set corresponding to a target user group and/or a target activity, and the first topic word is determined based on the target user group and/or the target activity;
or the first object set is determined based on an object set corresponding to a target category, and the first topic word is determined based on the target category.

In an optional implementation, the displaying a second page in response to a preset trigger operation for the first topic word includes:
displaying, in response to the preset trigger operation for the first topic word, a live streaming room page corresponding to the target live streaming room, where at least one live streaming object is displayed on the live streaming room page.

In an optional implementation, the method further includes:
displaying, in response to a trigger operation for the first object on the first page, an object details page corresponding to the first object, where the first topic word is displayed on the object details page, the first topic word is used to trigger a jump from the object details page to the live streaming room page corresponding to the target live streaming room.

In an optional implementation, the first object is a video object, an article object, an image-text object, or a life service object, the first object is displayed on a first object card, and the first topic word is displayed in a preset region of the first object card.

In an optional implementation, prior to the displaying the first page, the method further includes:
obtaining, in response to a display request for the first page, a set of objects to be displayed that correspond to the first page, where the set of objects to be displayed includes the first object; and
determining whether the first object has an associated topic word; and
correspondingly, the displaying the first page includes:
displaying the first page and displaying the first topic word on the first page, in response to determining that the first object has the associated first topic word.

In an optional implementation, prior to the displaying the first topic word on the first page in response to determining that the first object has the associated first topic word, the method further includes:
in response to determining that the first object has a plurality of associated topic words, determining the first topic word corresponding to the first object based on a preset topic word display strategy.

In an optional implementation, the displaying the first topic word on the first page includes:
displaying the first topic word on the first page based on a topic word display style corresponding to a topic word type to which the first topic word belongs.

In an optional implementation, the first topic word and the first object are displayed on the second page, and the at least one second object is displayed on the second page based on a preset category.

According to a second aspect, an embodiment of the present disclosure provides an object display apparatus. The apparatus includes:
a first display module configured to display a first page, where a first object and a first topic word are displayed on the first page, the first object belongs to a first object set obtained by aggregation based on the first topic word, and an object in the first object set has a description feature corresponding to the first topic word; and
a second display module configured to display a second page in response to a preset trigger operation for the first topic word, where at least one second object is displayed on the second page, the at least one second object belongs to the first object set, and the at least one second object includes at least one type of object from a live streaming object, a video object, an image-text object, and a life service object.

According to a third aspect, an embodiment of the present disclosure provides an electronic device. The electronic device includes:
one or more processors; and
a storage apparatus for storing one or more programs, where
the one or more programs, when executed by the one or more processors, cause the one or more processors to implement the object display method according to any one of the first aspect described above.

According to a fourth aspect, an embodiment of the present disclosure provides a computer-readable storage medium having a computer program stored thereon, wherein the program, when executed by a processor, implements the object display method according to any one of the first aspect described above.

The embodiments of the present disclosure provide an object display method and apparatus, a device, and a storage medium. The method includes: first, displaying the first page, where the first object and the first topic word are displayed on the first page, the first object belongs to the first object set obtained by aggregation based on the first topic word; and then, displaying the second page in response to the preset trigger operation for the first topic word, where the at least one second object is displayed on the second page, the second object belongs to the first object set, and the second object includes at least one type of object from a live streaming object, a video object, an image-text object, and a life service object.

### BRIEF DESCRIPTION OF THE DRAWINGS

The foregoing and other features, advantages, and aspects of embodiments of the present disclosure become more apparent with reference to the following specific implementations and accompanying drawings. Throughout the accompanying drawings, the same or similar reference numerals denote the same or similar elements. It is to be understood that the accompanying drawings are schematic and that parts and elements are not necessarily drawn to scale.

FIG. 1 is a schematic diagram of a scenario of an object display method according to an embodiment of the present disclosure;

FIG. 2 is a schematic flowchart of an object display method according to an embodiment of the present disclosure;

FIG. 3 is a schematic diagram of a second page according to an embodiment of the present disclosure;

FIG. 4 is a schematic diagram of a second page according to an embodiment of the present disclosure;

FIG. 5 is a schematic diagram of a first page according to an embodiment of the present disclosure;

FIG. 6 is a schematic structural diagram of an object display apparatus according to an embodiment of the present disclosure; and

FIG. 7 is a schematic structural diagram of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it is to be understood that the present disclosure may be implemented in various forms and may not be construed as being limited to the embodiments set forth herein. Rather, these embodiments are provided for a more thorough and complete understanding of the present disclosure. It is to be understood that the accompanying drawings and the embodiments of the present disclosure are only for exemplary purposes, and are not intended to limit the scope of protection of the present disclosure.

It is to be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” and variants thereof used herein indicate open inclusion, that is, “include/comprise but are not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It is to be noted that concepts such as “first” and “second” mentioned in the present disclosure are only used to distinguish different apparatuses, modules, or units, and are not used to limit the sequence of functions performed by these apparatuses, modules, or units or interdependence.

It is to be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

Before the embodiments of the present disclosure are further described in detail, nouns and terms involved in the embodiments of the present application are described, and the nouns and the terms involved in the embodiments of the present disclosure are applicable to the following explanations.

“In response to” is used for representing a condition or status on which an operation to be performed depends, where one or more operations may be performed in real time or after a set delay when conditions or statuses on which the operations depend are met. Unless explicitly stated, there is no limitation on the order in which the plurality of operations are performed.

In order to diversify the display manners of media resource objects, article objects, and the like, the embodiments of the present disclosure provide an object display method. The method includes: first, displaying a first page, where a first object and a first topic word are displayed on the first page, the first object belongs to a first object set obtained by aggregation based on the first topic word; and then, displaying a second page in response to a preset trigger operation for the first topic word, where at least one second object is displayed on the second page, the second object belongs to the first object set, and the second object includes at least one type of object from a live streaming object, a video object, an image-text object, and a life service object. In the embodiments of the present disclosure, the topic word and the first object from the object set obtained by aggregation based on the topic word are displayed, and an interaction function of displaying other objects aggregated under the topic word by clicking on the topic word is supported, thereby diversifying the display manners of media resource objects, article objects, and the like, meeting users' diverse display requirements for the objects, and improving the user experience.

The embodiments of the present disclosure are described in more detail below with reference to the accompanying drawings. It is to be noted that the same reference numerals in different accompanying drawings are used to denote the same elements that have been described.

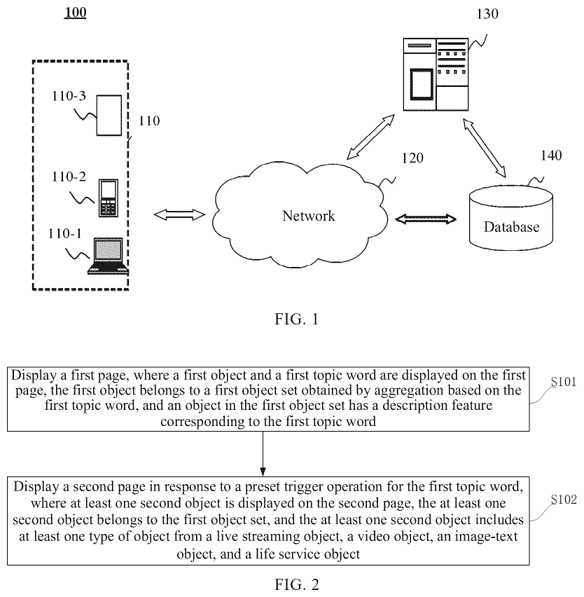

FIG. 1 is a schematic diagram of a scenario in which an object display method according to an embodiment of the present disclosure may be implemented. As shown in FIG. 1, a system 100 may include a plurality of user terminals 110, a network 120, a server 130, and a database 140. For example, the system 100 may be used to implement an object display method according to any embodiment of the present disclosure.

It is to be understood that the user terminals 110 may be any other type of electronic devices that can perform data processing, and may include, but are not limited to: mobile phones, stations, units, devices, multimedia computers, multimedia tablets, Internet nodes, communicators, desktop computers, laptop computers, notebook computers, netbook computers, tablet computers, personal communication system (PCS) devices, personal navigation devices, personal digital assistants (PDAs), audio/video players, digital cameras/camcorders, positioning devices, television receivers, radio receivers, e-book devices, game devices, or any combination thereof, including accessories and peripherals of these devices or any combination thereof.

A user may operate through an application installed on the user terminal 110. The application transmits user behavior data to the server 130 over the network 120, and further, the user terminal 110 may receive data transmitted by the server 130 over the network 120. The hardware system and software system of the user terminal 110 are not limited in the embodiments of the present disclosure. For example, the user terminal 110 may be based on a processor such as ARM and X86, may be provided with an input/output device such as a camera, a touch screen, and a microphone, and may have executed thereon an operating system, such as Windows, iOS, Linux, Android, and Harmony OS.

The user terminal 110 may implement the object display method according to the embodiment of the present disclosure by execution of a process or a thread. In some examples, the user terminal 110 may perform the object display method using a built-in application. In some other examples, the user terminal 110 may perform the object display method by calling an application stored externally to the user terminal 110.

The network 120 may be a single network, or a combination of at least two different networks. For example, the network 120 may include, but is not limited to, one or a combination of a local area network, a wide area network, a public network, a private network, and the like. The network 120 may be a computer network such as the Internet and/or a variety of telecommunication networks (e.g., 3G/4G/5G mobile communication networks, WIFI, Bluetooth, ZigBee, etc.), which is not limited in the embodiments of the present disclosure.

The server 130 may be a single server, or a server group, or a cloud server. In the case of a server group, servers in the server group are connected with each other through a wired or wireless network. The server group may be centralized, for example, a data center, or may be distributed. The server 130 may be local or remote. The server 130 may communicate with the user terminal 110 through a wired or wireless network. The hardware system and software system of the server 130 are not limited in the embodiments of the present disclosure.

The database 140 may generally be a device with a storage function. The database 140 is mainly used to store various data used, generated, and output by the user terminals 110 and the server 130 during operation. The database 140 may be local or remote. The database 140 may include a variety of memories, such as a random-access memory (RAM), or a read-only memory (ROM). The storage devices mentioned above are just some examples, and the storage devices that can be used by the system 100 are not limited thereto. The hardware system and software system of the database 140 are not limited in the embodiments of the present disclosure; for example, the database may be a relational database or a non-relational database.

The database 140 may be connected to or communicate with the server 130 or a part thereof through the network 120, or may be connected to or communicate with the server 130 directly; or the connection or communication may be performed by a combination of these two manners.

In some examples, the database 140 may be a separate device. In some other examples, the database 140 may alternatively be integrated in at least one of the user terminals 110 and the server 130. For example, the database 140 may be provided on the user terminals 110, or may be provided on the server 130. For another example, the database 140 may alternatively be distributed, with a part thereof being provided on the user terminals 110 and the other part thereof being provided on the server 130.

FIG. 2 is a flowchart of an object display method according to an embodiment of the present disclosure. This embodiment is applicable to a display scenario of media resource objects, article objects, and the like. The method may be performed by an object display apparatus. The object display apparatus may be implemented in the form of software and/or hardware. The object display method may be performed by the user terminal 110 in FIG. 1.

As shown in FIG. 2, the object display method according to the embodiment of the present disclosure mainly includes steps S101 to S103.

S101: display a first page,
where a first object and a first topic word are displayed on the first page, the first object belongs to a first object set obtained by aggregation based on the first topic word, and an object in the first object set has a description feature corresponding to the first topic word.

The first page may be any type of page. For example, the first page may be a commodity list page, a commodity recommendation page, or a video recommendation page, where at least the first object and the first topic word are displayed on the first page.

The topic word may be understood as, after objects having some similar or same points are clustered, textual information describing the similar or same points of this cluster of objects, that is, textual information used to describe a cluster of objects having the same or similar features.

In an implementation of the present disclosure, topic words may be divided into various types; for example, the topic words may include hotspot-type topic words, brand-type topic words, category-type topic words, season-type topic words, live-streaming-type topic words, streamer-type topic words, list-type topic words, channel-type topic words, new-product-type topic words, activity-type topic words, and user-group-type topic words.

In an optional implementation, the first object set is determined based on a live streaming object set corresponding to a target live streaming room, and the first topic word is determined based on the target live streaming room. Specifically, the first topic word belongs to the live-streaming-type topic words or the streamer-type topic words. For example, the live-streaming-type topic word may be a topic word obtained by directly using a name of a live streaming room as the topic word. The streamer-type topic word may be understood as a topic word obtained by directly using a streamer name as the topic word. For example, the topic word is AAAA (AAAA is a streamer name of a popular streamer). The streamer-type topic word may alternatively be understood as a topic word formed by a streamer name and a commodity category. For example, the topic word is “Fitness list recommended by AAAA”, where fitness is a category of commodity.

In another optional implementation, the first object set is determined based on a listed object set corresponding to a first list, and the first topic word is determined based on a list name of the first list. Specifically, the first topic word belongs to the list-type topic words. The list-type topic word may be understood as a topic word corresponding to a certain type of list. For example, the topic word is “** best-selling list”.

In another optional implementation, the first object set is determined based on a new product object set, and the first topic word is a new product description word. For example, the topic word is “New arrivals”.

In another optional implementation, the first object set is determined based on an object set corresponding to a target user group and/or a target activity, and the first topic word is determined based on the target user group and/or the target activity. Specifically, the first topic word belongs to the activity-type topic words, specific-user-group-type topic words, or the like. The activity topic word may be understood as a topic word formed from a promotion activity currently being carried out by a merchant or a platform. For example, the topic word is “Double 11”. The specific-user-group-type topic word may be understood as a topic word formed after classification of target population, for example, “Gifts for girlfriend”, “Father's Day shopping list”, etc. The first topic word may alternatively be determined based on a combination of the target user group and the target activity, for example, “Gifts for mom on Mother's Day”.

In another optional implementation, the first object set is determined based on an object set corresponding to a target category, and the first topic word is determined based on the target category. Specifically, the first topic word belongs to the brand-type topic words or season-type topic words. The brand-type topic word may be understood as a topic word obtained by using a brand as the topic word. The season-type topic word may be understood as a topic word generated based on a season or time, for example, “Spring clothing renewal season”, and “Winter outfits”.

In an optional implementation, the topic word may be a word manually input by operation personnel, or may be obtained by clustering based on user behavior data. Specifically, for the streamer-type topic word, first, user behavior data and live streaming data corresponding to a plurality of streamers are obtained; for each streamer, a popularity value corresponding to the streamer is determined based on the user behavior data and the live streaming data corresponding to the streamer; and a target streamer is selected from the plurality of streamers based on popularity values.

The user behavior data corresponding to the streamer includes: the number of fans corresponding to the streamer, and the number of positive reviews received by the streamer. The live streaming data may include the maximum number of online users in the live streaming room, the sales number of commodities, the sales amount of commodities, and the like during the live streaming hosted by the streamer. It is to be noted that the user behavior data and the live streaming data are data made public by users or streamers and available over the network.

In an embodiment of the present disclosure, popularity values corresponding to streamers are calculated based on the user behavior data and live streaming data corresponding to the streamers, and a method for calculating the popularity values; and a streamer with the highest popularity value is determined as a target streamer, or streamers with the top N popularity values are determined as target streamers. It is to be noted that there may be one or a plurality of target streamers, and a plurality of topic words are determined in the case of a plurality of target streamers. The number of target topics is not specifically limited in the embodiments of the present disclosure.

In the embodiment of the present disclosure, the first object may belong to any one of object sets, and the first object may be a live streaming object, a video object, an image-text object, a life service object, or the like.

Herein, the live streaming object may be an object that is presented in a live streaming room of a streamer. The video object may be a video for users to browse. The life service object may be a life-related service, such as a takeaway merchant and a surrounding tour service. The image-text object may be an object that shows content in the form of a picture and text. The object set is obtained by aggregating objects under the same topic word, where any object in the object set has a correspondence with the topic word and satisfies a description feature corresponding to the topic word.

In the embodiment of the present disclosure, the first page is displayed, and the first object and the first topic word are displayed on the first page, where the first object belongs to a first object set obtained by aggregation based on the first topic word, and the first object has the description feature corresponding to the first topic word.

S102: Display a second page in response to a preset trigger operation for the first topic word,
where at least one second object is displayed on the second page, the at least one second object belongs to the first object set, and the at least one second object includes at least one type of object from a live streaming object, a video object, an image-text object, and a life service object.

In an embodiment of the present disclosure, the second page may be a commodity details page, a live streaming room page, or the like, where each object displayed on the second page belongs to the first object set obtained by aggregation based on the first topic word.

In an embodiment of the present disclosure, the second object is displayed on the second page. In addition, the first object may also be displayed on the second page. Preferably, the first object may be displayed at the first position on the second page.

In addition, in an embodiment of the present disclosure, the object displayed on the second page may specifically be one type of object from a live streaming object, a video object, an image-text object, a life service object, and the like; and the first object set may include a plurality of types of objects, for example, a live streaming object, a video object, an image-text object, a life service object, and the like.

In an optional implementation, when the first object set is live streaming objects displayed in a live streaming room of a streamer, the first topic word may be the name of the live streaming room, and upon reception of a trigger operation for the topic word, the second page, i.e., the live streaming room page, is displayed, where the category of products sold in the live streaming room is the second object.

In an optional implementation, the first object set is determined by a listed object set corresponding to a first list, and the first topic word is determined based on a list name of the first list. For example, the topic word is “Best value *** No. 5”, and the first object set is all essence lotions in a best value essence lotion list. Upon reception of a trigger operation for the topic word, the second page, i.e., a best value essence lotion list page, is displayed, where the various essence lotions displayed on the best value essence lotion list page are the second objects.

In another optional implementation, the first object set is determined based on a new product object set, and the first topic word is a new product description word. For example, the topic word is “** new products launch”, and the first object set is a set of “** new products” recently released under the topic word. Upon reception of a trigger operation for the topic word, the second page, i.e., a page related to “** new products”, is displayed, where the object displayed on the page is the second object, which may be a video object, an image-text object, or the like.

In yet another optional implementation, the first object set is determined based on an object set corresponding to a target user group and/or a target activity, and the first topic word is determined based on the target user group and/or the target activity. For example, the topic word is “Most beautiful teacher”, and the first object set is a group of people who qualify as “Most beautiful teacher”. For another example, the topic word is “Chinese New Year essentials”, and the first object set is goods corresponding to the activity Chinese New Year. For yet another example, the topic word is “Mother's Day goodies selection”, and the first object set is all selected items suitable for the target user group “mother” and the target activity “Mother's Day”. The topic word may alternatively be “Hassle-free May Day travel”, and the first object set is a collection of related content about traveling during the May Day holiday.

Upon reception of a trigger operation for any one of the topic words mentioned above, a corresponding second page is displayed, where the object displayed on the page is a second object, which may be a video object, an image-text object, a life service object, or the like.

In another optional implementation, the first object set is determined based on an object set corresponding to a target category, and the first topic word is determined based on the target category.

The target category may be a brand, a season/time, or the like. For example, the topic word is “** air conditioner”, and the first object set is all air conditioners based on the “**” brand. For another example, the topic word is “Spring clothing renewal season”, and the first object set is all clothing based on this season. For yet another example, the topic word is “Health preservation during dog days”, and the first object set is content related to health preservation during the dog days. Upon reception of a corresponding trigger operation for any one of the topic words mentioned above, a corresponding second page is displayed, where one or more objects belonging to the first object set are displayed on the second page, which may specifically be a video object, an image-text object, or the like.

In another optional implementation, the topic word is current cyberword or popular buzzword, and the first object set is a collection of related content that matches the topic word.

For example, the topic word may be “White moonlight” (someone who is considered ideal but unattainable), “Face of first-love” (a face with first-love feeling), “Tai Ku La” (very cool), or the like, and the first object set is a collection of all content related to the topic word.

Upon reception of a corresponding trigger operation for any one of the topic words mentioned above, a corresponding second page is displayed, where a plurality of objects belonging to the first object set are displayed on the second page, which may specifically be video objects, image-text objects, or the like.

On the basis of the above-mentioned implementations, upon reception of a trigger for the first topic word on the first page, the second page is displayed, and the second object belonging to the first object set is displayed on the second page. For the displayed second object in the first object set, in order to facilitate a user to find an object of interest more quickly, objects in the first object set may be further classified.

Specifically, in an embodiment of the present disclosure, the first topic word and the first object are displayed on the second page, and the at least one second object is displayed on the second page based on a preset category, that is, the objects in the object set are specifically classified and displayed on the second page.

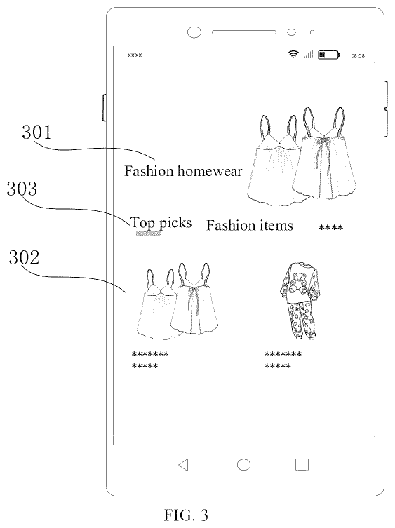

For example, FIG. 3 is a schematic diagram of a second page according to an embodiment of the present disclosure. A first topic word 301, a first object 302, and preset categories “Top picks” and “Fashion items” are displayed on the second page, as indicated by 302, where different categories may be preset as the preset categories based on the types of objects.

In actual applications, by triggering a topic word displayed on the first page, a user enters a corresponding second page and browses various objects under the topic word; if the user wants to know details of a specific object under the topic word, the user may trigger the first object on the first page.

Specifically, in response to a trigger operation for the first object on the first page, an object details page corresponding to the first object is displayed, where the first topic word is displayed on the object details page, and the first topic word is used to trigger a jump from the object details page to a page corresponding to the topic word.

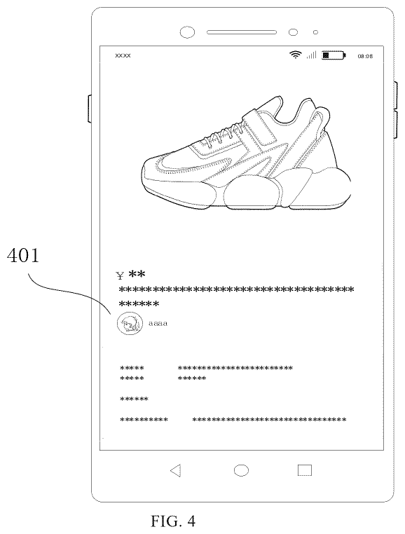

For example, FIG. 4 is a schematic diagram of a second page according to an embodiment of the present disclosure. Assuming that a topic word is the name of a live streaming room, as indicated by 401, upon reception of a trigger operation for a first object on a first page, a specific details page of the first object is displayed. The topic word 401 is also displayed on the specific details page. Upon reception of a trigger operation for the topic word on the object details page, a jump to the live streaming room of “aaaa” is performed when it is detected that the current live streaming room is in a live streaming state.

In an embodiment of the present disclosure, different types of topic words are determined. Based on this, different types of objects that match the different types of topic words are determined, and object sets are obtained by aggregation. Then, any object belonging to an object set and a corresponding topic word are displayed on the first page.

Since a plurality of topic words may be displayed on the first page, when the plurality of topic words and objects under the respective topic words are displayed, in order to facilitate a user to intuitively view the topic words and the objects described by the topic words, the topic words are required to have obvious correspondences with their corresponding objects.

To this end, in an embodiment of the present disclosure, a plurality of object cards are displayed on the first page to display the objects and the corresponding topic words, so that the user can intuitively view the correspondences between the objects and the topic words, thereby improving the user experience.

Specifically, the plurality of object cards are displayed on the first page, the first object is displayed on a first object card, and the first topic word is displayed in a preset region of the first object card. Referring to FIG. 4, which is a schematic diagram of a display of a first page according to an embodiment of the present disclosure. A first object 401 and a topic word 402 are displayed on a same object card.

In actual applications, not all pages browsed by the user display topic words. In an embodiment of the present disclosure, it is determined whether to display a topic word on the first page by obtaining the first object set on the first page and determining whether an object in the first object set has an associated topic word. The specific method may be implemented through software/hardware.

In an optional implementation, upon reception of a display request for the first page, a set of objects to be displayed that correspond to the first page is obtained, where the set of objects to be displayed includes the first object; and then, it is determined whether the first object has an associated topic word. If it is determined that the first object has the associated first topic word, the first page is displayed and the first topic word is displayed on the first page; otherwise, the first page is displayed without displaying the topic word.

Based on the determination that the first object on the first page has the associated topic word, when it is determined that the first object has a plurality of associated topic words, the first topic word corresponding to the first object is determined based on a preset topic word display strategy.

In an optional implementation, according to the topic word display strategy, a topic word to be displayed may be determined based on a priority that is based on, for example, the popularity value of the topic word, whether the topic word is appropriate for the time and the occasion, etc.

For example, the plurality of topic words associated with the first object include “Sales No. 1” and “Gifts for Chinese New Year”, and it is currently during the Chinese New Year, then the topic word “Gifts for Chinese New Year” is displayed preferentially.

Display of the object cards and the objects on the first page and display of the topic words on the object cards based on priorities allow the user to be guided to better browse the page, thereby improving the user experience.

In addition, the topic words may further have different display styles, to enhance the appeal to the user and achieve a better user experience.

In an optional implementation, when the topic word is the name of a well-known live streaming room, and the current live streaming room is in live streaming, the display style of the topic word may be displaying an avatar with a live streaming identifier of the live streaming room, along with content of the topic word.

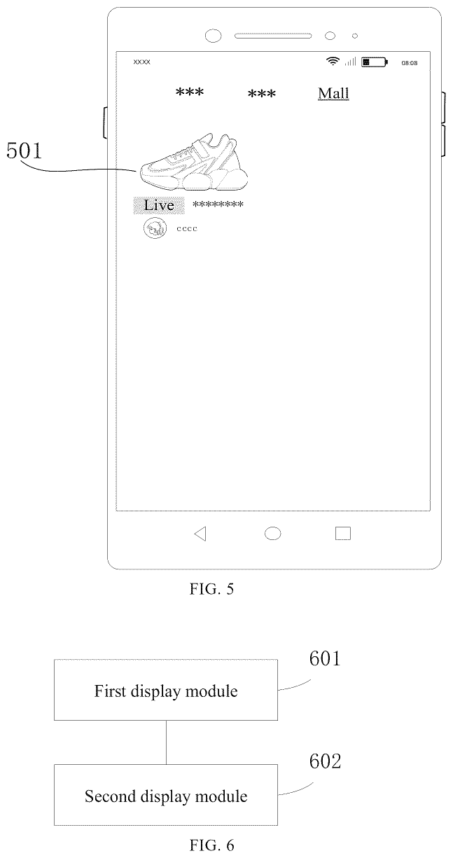

For example, FIG. 5 is a schematic diagram of a first page according to an embodiment of the present disclosure. A first object card is displayed on the first page, and a first object and a first topic word “cccc” are displayed on the first object card. When it is detected that the current live streaming room is in live streaming, the display style of the topic word may be displaying a live streaming identifier, a live streaming avatar, and the topic word, as indicated by 501.

In an optional implementation, when the topic word contains the name of a famous person or a person with great dissemination influence, the display style of the topic word may be displaying the name of the person and related content, for example, AA's fitness recommendation list, Li Dazhao New Youth.

In another optional implementation, when the topic word contains a famous brand, the display style of the topic word may be displaying the logo of the brand and the content of the topic word.

Based on different types of topic words, the topic words are displayed in different styles, thereby diversifying the display styles of the topic words, enhancing the appeal to the user, and improving the user experience.

In the object display method according to the embodiments of the present disclosure, first, the first page is displayed, where the first object and the first topic word are displayed on the first page, the first object belongs to the first object set obtained by aggregation based on the first topic word; and then, the second page is displayed in response to the preset trigger operation for the first topic word, where the at least one second object is displayed on the second page, the second object belongs to the first object set, and the second object includes at least one type of object from a live streaming object, a video object, an image-text object and a life service object. In the embodiments of the present disclosure, the topic word and the first object from the object set obtained by aggregation based on the topic word are displayed, and an interaction function of displaying other objects aggregated under the topic word by clicking on the topic word is supported, thereby diversifying the display manners of media resource objects, article objects, and the like, meeting users' diverse display requirements for the objects, and improving the user experience.

Based on the method embodiments described above, the present disclosure further provides an object display apparatus. FIG. 6 is a schematic structural diagram of an object display apparatus according to an embodiment of the present disclosure. The apparatus includes:
a first display module 601 configured to display a first page, where a first object and a first topic word are displayed on the first page, the first object belongs to a first object set obtained by aggregation based on the first topic word, and an object in the first object set has a description feature corresponding to the first topic word; and
a second display module 602 configured to display a second page in response to a preset trigger operation for the first topic word, where at least one second object is displayed on the second page, the at least one second object belongs to the first object set, and the at least one second object includes at least one type of object from a live streaming object, a video object, an image-text object, and a life service object.

In an optional implementation, the first object set is determined based on a live streaming object set corresponding to a target live streaming room, and the first topic word is determined based on the target live streaming room;
or the first object set is determined based on a listed object set corresponding to a first list, and the first topic word is determined based on a list name of the first list;
or the first object set is determined based on a new product object set, and the first topic word is a new product description word;
or the first object set is determined based on an object set corresponding to a target user group and/or a target activity, and the first topic word is determined based on the target user group and/or the target activity;
or the first object set is determined based on an object set corresponding to a target category, and the first topic word is determined based on the target category.

In an optional implementation, the second display module is specifically configured to:
display, in response to the preset trigger operation for the first topic word, a live streaming room page corresponding to the target live streaming room, where at least one live streaming object is displayed on the live streaming room page.

In an optional implementation, the apparatus further includes:
a third display module configured to display, in response to a trigger operation for the first object on the first page, an object details page corresponding to the first object, where the first topic word is displayed on the object details page, the first topic word is used to trigger a jump from the object details page to the live streaming room page corresponding to the target live streaming room.

In an optional implementation, the first object is a video object, an article object, an image-text object, or a life service object, the first object is displayed on a first object card, and the first topic word is displayed in a preset region of the first object card.

In an optional implementation, the apparatus further includes:
an obtaining module configured to obtain, in response to a display request for the first page, a set of objects to be displayed that correspond to the first page; where the set of objects to be displayed includes the first object; and
a first determination module configured to determine whether the first object has an associated topic word; and
correspondingly, the first display module is specifically configured to:
display the first page and display the first topic word on the first page, in response to determining that the first object has the associated first topic word.

In an optional implementation, the apparatus further includes:
a second determination module configured to determine, in response to determining that the first object has a plurality of associated topic words, the first topic word corresponding to the first object based on a preset topic word display strategy.

In an optional implementation, the first display module further includes:
a display sub-module configured to display the first topic word on the first page based on a topic word display style corresponding to a topic word type to which the first topic word belongs.

In an optional implementation, the first topic word and the first object are displayed on the second page, and the at least one second object is displayed on the second page based on a preset category.

In the object display apparatus according to the embodiment of the present disclosure, first, the first page is displayed, where the first object and the first topic word are displayed on the first page, the first object belongs to the first object set obtained by aggregation based on the first topic word; and then, the second page is displayed in response to the preset trigger operation for the first topic word, where the at least one second object is displayed on the second page, the second object belongs to the first object set, and the second object includes at least one type of object from a live streaming object, a video object, an image-text object and a life service object. In the embodiments of the present disclosure, the topic word and the first object from the object set obtained by aggregation based on the topic word are displayed, and an interaction function of displaying other objects aggregated under the topic word by clicking on the topic word is supported, thereby diversifying the display manners of media resource objects, article objects, and the like, meeting users' diverse display requirements for the objects, and improving the user experience.

In addition to the method and apparatus described above, an embodiment of the present disclosure further provides a computer-readable storage medium having instructions stored thereon. The instructions, when executed on a terminal device, cause the terminal device to implement the object display method described in the embodiments of the present disclosure.

An embodiment of the present disclosure further provides a computer program product. The computer program product includes a computer program or instructions. The computer program or instructions, when executed by a processor, cause the object display method described in the embodiments of the present disclosure to be implemented.

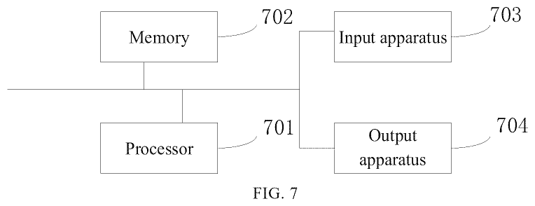

In addition, an embodiment of the present disclosure further provides an object display device. As shown in FIG. 7, the device may include:
a processor 701, a memory 702, an input apparatus 703, and an output apparatus 704. There may be one or more processors 701 in the data processing device. For example, there is one processor in FIG. 7. In some embodiments of the present disclosure, the processor 701, the memory 702, the input apparatus 703, and the output apparatus 704 may be connected through a bus or in another manner, for example, are connected through the bus in FIG. 7.

The memory 702 may be used to have stored therein a software program and a module. The processor 701 performs various functional applications of the data processing device and processes data by executing the software program and the module stored in the memory 702. The memory 702 may mainly include a program storage area and a data storage area, where the program storage area may have stored therein an operating system, an application required by at least one function, and the like. In addition, the memory 702 may include a high-speed random-access memory, and may further include a non-volatile memory, such as at least one magnetic disk storage device, a flash memory device, or other volatile solid-state storage devices. The input apparatus 703 may be used to receive input numerical or character information, and generate a signal input related to a user setting and function control of the data processing device.

Specifically, in this embodiment, the processor 701 loads an executable file corresponding to a process of one or more applications into the memory 702 in accordance with the following instructions, and the processor 701 executes the application stored in the memory 702, to implement various functions of the object display device described above.

It is to be noted that the relational terms such as “first” and “second” herein are only used to distinguish one entity or operation from another, and do not necessarily require or imply that any actual relationship or sequence exists between these entities or operations. Moreover, the terms “include”, “including”, “comprise” and “comprising”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments described herein, but extends to the widest scope that complies with the principles and novelty disclosed in this specification.

1. An object display method, comprising:
displaying a first page, wherein a first object and a first topic word are displayed on the first page, the first object belongs to a first object set obtained by aggregation based on the first topic word, and an object in the first object set has a description feature corresponding to the first topic word; and
displaying a second page in response to a preset trigger operation for the first topic word, wherein at least one second object is displayed on the second page, the at least one second object belongs to the first object set, and the at least one second object comprises at least one type of object from a live streaming object, a video object, an image-text object, and a life service object.

2. The method according to claim 1, wherein at least one of the following:
the first object set is determined based on a live streaming object set corresponding to a target live streaming room, and the first topic word is determined based on the target live streaming room;
the first object set is determined based on a listed object set corresponding to a first list, and the first topic word is determined based on a list name of the first list;
the first object set is determined based on a new product object set, and the first topic word is a new product description word;
the first object set is determined based on an object set corresponding to at least one of a target user group or a target activity, and the first topic word is determined based on at least one of the target user group or the target activity; or
the first object set is determined based on an object set corresponding to a target category, and the first topic word is determined based on the target category.

3. The method according to claim 2, wherein the displaying a second page in response to a preset trigger operation for the first topic word comprises:
displaying, in response to the preset trigger operation for the first topic word, a live streaming room page corresponding to the target live streaming room, wherein at least one live streaming object is displayed on the live streaming room page.

4. The method according to claim 2, wherein the method further comprises:
displaying, in response to a trigger operation for the first object on the first page, an object details page corresponding to the first object, wherein the first topic word is displayed on the object details page, the first topic word is used to trigger a jump from the object details page to the live streaming room page corresponding to the target live streaming room.

5. The method according to claim 1, wherein the first object is at least one of a video object, an article object, an image-text object, or a life service object, the first object is displayed on a first object card, and the first topic word is displayed in a preset region of the first object card.

6. The method according to claim 1, wherein prior to the displaying the first page, the method further comprises:
obtaining, in response to a display request for the first page, a set of objects to be displayed that correspond to the first page, wherein the set of objects to be displayed includes the first object; and
determining whether the first object has an associated topic word; and
correspondingly, the displaying the first page comprises:
displaying the first page and displaying the first topic word on the first page, in response to determining that the first object has the associated first topic word.

7. The method according to claim 6, wherein prior to the displaying the first topic word on the first page in response to determining that the first object has the associated first topic word, the method further comprises:
in response to determining that the first object has a plurality of associated topic words, determining the first topic word corresponding to the first object based on a preset topic word display strategy.

8. The method according to claim 6, wherein the displaying the first topic word on the first page comprises:
displaying the first topic word on the first page based on a topic word display style corresponding to a topic word type to which the first topic word belongs.

9. The method according to claim 1, wherein the first topic word and the first object are displayed on the second page, and the at least one second object is displayed on the second page based on a preset category.

10. (canceled)

11. An electronic device, comprising:
one or more processors; and
a storage apparatus for storing one or more instructions, wherein:
the one or more instructions, when executed by the one or more processors, cause the one or more processors to:
display a first page, wherein a first object and a first topic word are displayed on the first page, the first object belongs to a first object set obtained by aggregation based on the first topic word, and an object in the first object set has a description feature corresponding to the first topic word; and
display a second page in response to a preset trigger operation for the first topic word, wherein at least one second object is displayed on the second page, the at least one second object belongs to the first object set, and the at least one second object comprises at least one type of object from a live streaming object, a video object, an image-text object, and a life service object.

12. A non-transitory computer-readable storage medium having computer instructions stored thereon, wherein the instructions, when executed by a processor, cause the processor to:
display a first page, wherein a first object and a first topic word are displayed on the first page. the first object belongs to a first object set obtained by aggregation based on the first topic word, and an object in the first object set has a description feature corresponding to the first topic word; and
display a second page in response to a preset trigger operation for the first topic word, wherein at least one second object is displayed on the second page, the at least one second object belongs to the first object set, and the at least one second object comprises at least one type of object from a live streaming object, a video object, an image-text object, and a life service object.

13. The electronic device according to claim 11, wherein at least one of the following:
the first object set is determined based on a live streaming object set corresponding to a target live streaming room, and the first topic word is determined based on the target live streaming room;
the first object set is determined based on a listed object set corresponding to a first list, and the first topic word is determined based on a list name of the first list;
the first object set is determined based on a new product object set, and the first topic word is a new product description word;
the first object set is determined based on an object set corresponding to at least one of a target user group or a target activity, and the first topic word is determined based on at least one of the target user group or the target activity; or
the first object set is determined based on an object set corresponding to a target category, and the first topic word is determined based on the target category.

14. The electronic device according to claim 13, wherein the instructions to display the second page in response to the preset trigger operation for the first topic word comprises instructions to:
display, in response to the preset trigger operation for the first topic word, a live streaming room page corresponding to the target live streaming room, wherein at least one live streaming object is displayed on the live streaming room page.

15. The electronic device according to claim 13, wherein the instructions further comprise instructions to:
display, in response to a trigger operation for the first object on the first page, an object details page corresponding to the first object, wherein the first topic word is displayed on the object details page, the first topic word is used to trigger a jump from the object details page to the live streaming room page corresponding to the target live streaming room.

16. The electronic device according to claim 11, wherein the first object is at least one of a video object, an article object, an image-text object, or a life service object, the first object is displayed on a first object card, and the first topic word is displayed in a preset region of the first object card.

17. The electronic device according to claim 11, wherein prior to the instructions to display the first page, the instructions further comprise instructions to:
obtain, in response to a display request for the first page, a set of objects to be displayed that correspond to the first page, wherein the set of objects to be displayed includes the first object; and
determine whether the first object has an associated topic word; and
correspondingly, the instructions to display the first page comprise instructions to:
display the first page and displaying the first topic word on the first page, in response to determining that the first object has the associated first topic word.

18. The electronic device according to claim 17, wherein prior to the instructions to display the first topic word on the first page in response to determining that the first object has the associated first topic word, the instructions further comprise instructions to:
in response to determining that the first object has a plurality of associated topic words, determine the first topic word corresponding to the first object based on a preset topic word display strategy.

19. The electronic device according to claim 17, wherein the instructions to display the first topic word on the first page comprise instructions to:
display the first topic word on the first page based on a topic word display style corresponding to a topic word type to which the first topic word belongs.

20. The electronic device according to claim 11, wherein the first topic word and the first object are displayed on the second page, and the at least one second object is displayed on the second page based on a preset category.

21. The non-transitory computer-readable storage medium according to claim 12, wherein at least one of the following:
the first object set is determined based on a live streaming object set corresponding to a target live streaming room, and the first topic word is determined based on the target live streaming room;
the first object set is determined based on a listed object set corresponding to a first list, and the first topic word is determined based on a list name of the first list;
the first object set is determined based on a new product object set, and the first topic word is a new product description word;
the first object set is determined based on an object set corresponding to at least one of a target user group or a target activity, and the first topic word is determined based on at least one of the target user group or the target activity; or
the first object set is determined based on an object set corresponding to a target category, and the first topic word is determined based on the target category.
